(19) United States
(12) Patent Application Publication
(10) Pub. No.: US 2022/0174860 A1
(43) Pub. Date: Jun. 9, 2022

(54) BAG SPREADER

(71) Applicant: Earthway Products Inc, Bristol, IN (US)

(72) Inventors: Richard Sevrey, Bristol, IN (US); Joey Arthur, Mishawaka, IN (US); Tim Jones, Osceola, IN (US); John Marshall, Granger, IN (US); Justin B. Parizek, Millersburg, IN (US); Joe Jimenez, Elkhart, IN (US); Jeff Harbrecht, Elkhart, IN (US)

(21) Appl. No.: 17/115,333

(22) Filed: Dec. 8, 2020

(51) Int. Cl. A01C 17/00; B05B 11/00; A01C 21/00; A01C 15/02

(52) U.S. Cl. CPC A01C 17/001; B05B 11/0037; A01C 15/02; A01C 21/00; B05B 11/0008

(57) ABSTRACT

An improved bag spreader and methods of the using the same. The bag spreader includes a bag that holds particulate material, a base removably coupled to the bag and including an exit opening to permit the particulate material to fall therethrough, an impeller below the base and configured to receive the particulate material leaving the exit opening and spread the particulate material, and a fastener circumscribing the base and securing the bag to the base. The methods include removably securing a bag to a base using a single cable tie, filling the bag with particulate material, and turning a hand crank causing the impeller to spin and spread the particulate material.

### TECHNICAL FIELD

The present invention relates to an improved particulate dispersing apparatus and, more specifically, to an improved bag spreader.

### BACKGROUND OF THE INVENTION

Many different types of broadcast spreaders are used to distribute particulate material or granules such as fertilizer, grass seed, salt, sand, ice melt, and others to lawns, golf courses, turf, sidewalks, parking lots, and various other surfaces. Handheld spreaders are useful for small applications, tight spaces, or hilly or wet terrain where a rolling spreader would be impractical or undesirable. Some handheld spreaders, referred to generally as bag spreaders, generally include a nylon bag operatively attached to and disposed above a molded plastic base that includes one or more openings provided above a rotating impeller. The nylon bag is configured to receive particulate material to be spread about a surface, which is most often grass seed, but which may also include other particulate material such as fertilizer, salt, sand, ice melt, and others. A shut-off plate is provided below the one or more openings to selectively open and close the openings in the base thereby permitting or restricting, respectively, granules from falling on the impeller, which in turn flings and thus distributes granules on the area being treated.

Many known bag spreaders include a rectangular base affixed to the nylon bag. This can be uncomfortable during use because one or more of the four right-angled corners of the base can dig into the user's torso during use. According, other known bag spreaders include a “kidney-shaped” base having a contoured outer circumferential face which includes one or more concave indentations configured to rest against a user during use. In either case, the right-angled base or the base including concave indentions include tight interior corners and other areas where seed or other particulate material becomes trapped during use, making it very difficult to fully empty the contents of the spreaders. Additionally, the right-angled base or the base including concave indentions necessitate that the nylon bag be semi-permanently affixed in place via staples or similar in order for the bag to follow the irregular circumference of the base. This makes replacement of the nylon bag difficult because each staple or similar fastener must be removed and the new bag must in turn be stapled back into place.

There thus remains a need for a handheld broadcast bag spreader that overcomes one or more of these deficiencies of known bag type spreaders. More particularly, there remains a need for a handheld broadcast bag spreader that includes a base that does not trap grass seed or other particulate material during use, and/or for a handheld broadcast bag spreader in which the bag or similar hopper can be easily removed and replaced as necessary.

### BRIEF SUMMARY OF THE INVENTION

The instant invention is generally directed to a bag spreader with an improved base that overcomes the deficiencies of known bag spreaders discussed above, and methods of using the same.

More particularly, some embodiments of the instant invention are directed to an improved bag spreader. The bag spreader includes a bag configured to hold particulate material to be spread about a surface, a base removably coupled to the bag and including an exit opening to permit the particulate material to fall therethrough when the particulate material is being spread about the surface, an impeller below the base and configured to receive the particulate material leaving the exit opening and spread the particulate material about the surface, and a fastener circumscribing the base and securing the bag to the base.

Other embodiments of the invention are directed to an improved bag spreader. The bag spreader includes a bag configured to hold particulate material to be spread about a surface including an open lower end and a base that includes a circumferentially extending wall, a channel within the circumferentially extending wall, and an exit opening to permit the particulate material to fall therethrough when the particulate material is being spread about the surface. The bag spreader also includes an impeller below the base and configured to receive the particulate material leaving the exit opening and spread the particulate material about the surface, and a fastener circumscribing the base and the open lower end of the bag such that the open lower end of the bag is sandwiched between the fastener and the channel provided in the circumferentially extending wall.

Still other embodiments of the invention are directed to a method of operating a bag spreader. The method includes removably securing a bag to a base using a single cable tie. The method also includes filling the bag with particulate material and turning a hand crank causing an impeller to spin and spread the particulate material passing through an exit opening in the base.

These and other features will be discussed in more detail in connection with the accompanying drawings.

### BRIEF DESCRIPTION OF THE SEVERAL VIEWS OF THE DRAWINGS

The present invention is described in detail below with reference to the attached drawing figures, wherein:

FIG. 1 is a perspective view of a first embodiment of a bag spreader according to aspects of the invention;

FIG. 2 is a perspective view of the bag spreader shown in FIG. 1 with the bag removed to show internal components thereof;

FIG. 3 is a top view of the bag spreader shown in FIG. 2;

FIG. 4 is a bottom view of the bag spreader shown in FIGS. 2-3;

FIG. 5 is a left side view of the bag spreader shown in FIGS. 2-4;

FIG. 6 is a bottom view of the bag spreader shown in FIGS. 2-5 with the impeller removed to show internal components thereof;

FIG. 7 is a perspective view of a second embodiment of a bag spreader according to aspects of the invention with the bag removed to show internal components thereof; and

FIG. 8 is a top view of the bag spreader shown in FIG. 7.

### DETAILED DESCRIPTION OF THE INVENTION

At a high level, the subject matter of this application generally relates to handheld broadcast spreaders used to distribute granules such as fertilizer, grass seed, and other grass treatments on lawns, golf courses, and other turf, or used to distribute granules such as salt, sand, ice melt, and others on a variety of surfaces. The spreader includes an innovative base that provides enhanced particulate distribution during use of the spreader and that enables a nylon bag or similar hopper to be easily and efficiently removed and replaced simply by removing and securing, respectively, a cable tie or similar fastener.

The base is rounded—that is the base includes a circular, oval-shaped, stadium-shaped, or similar outer circumference—and/or may include a sloped floor that directs grass seed or other particulate material towards an opening in the lowermost portion of the floor. The rounded outer circumference and/or sloped floor ensures grass seed or other particulate material does not become caught in the base during use, thus providing enhanced particulate distribution as compared to known bag spreaders. The sloped floor further directs grass seed towards and center and lowermost portion of the floor of the base, thus providing a low and centralized center of gravity during filling, reducing tipping of the bag spreader during filling or when resting on the ground.

The base may further include a circumferentially extending channel to receive a cable tie or similar fastener that secures the open, lower end of the bag in place. The cable tie or similar fastener circumscribes the circumferentially extending channel and sandwiches the lower end of the bag between the tie and the channel securing the bag in place. This provides for easy and efficient replacement of the bag by simply removing the tie, replacing the bag, and fastening the tie (or a replacement tie) in place, and notably without requiring a user to, for example, remove staples or similar semi-permanent fasteners and in turn staple a new bag in place.

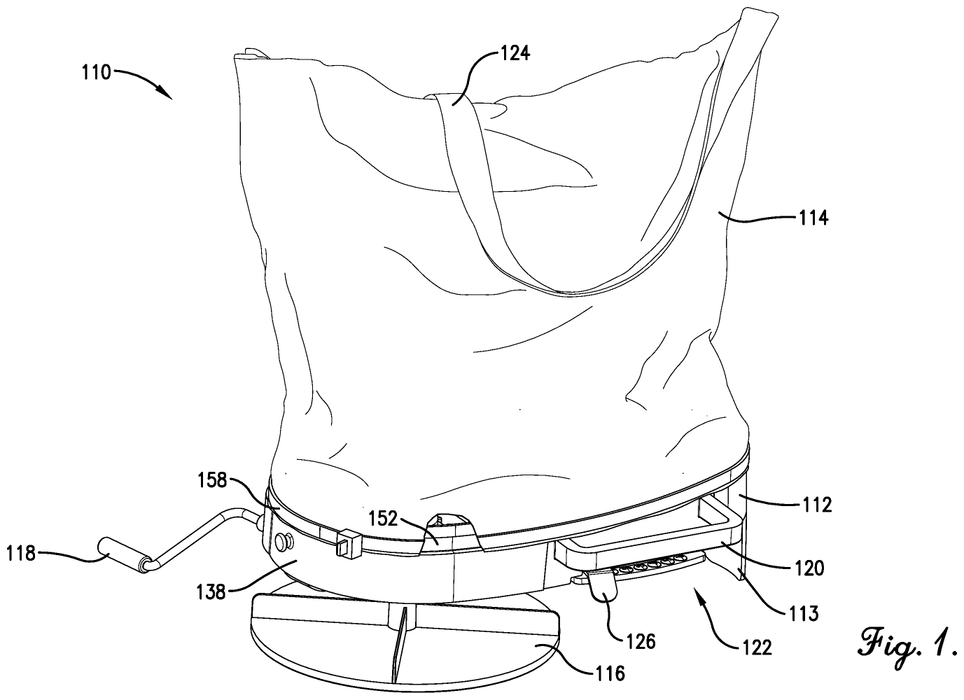

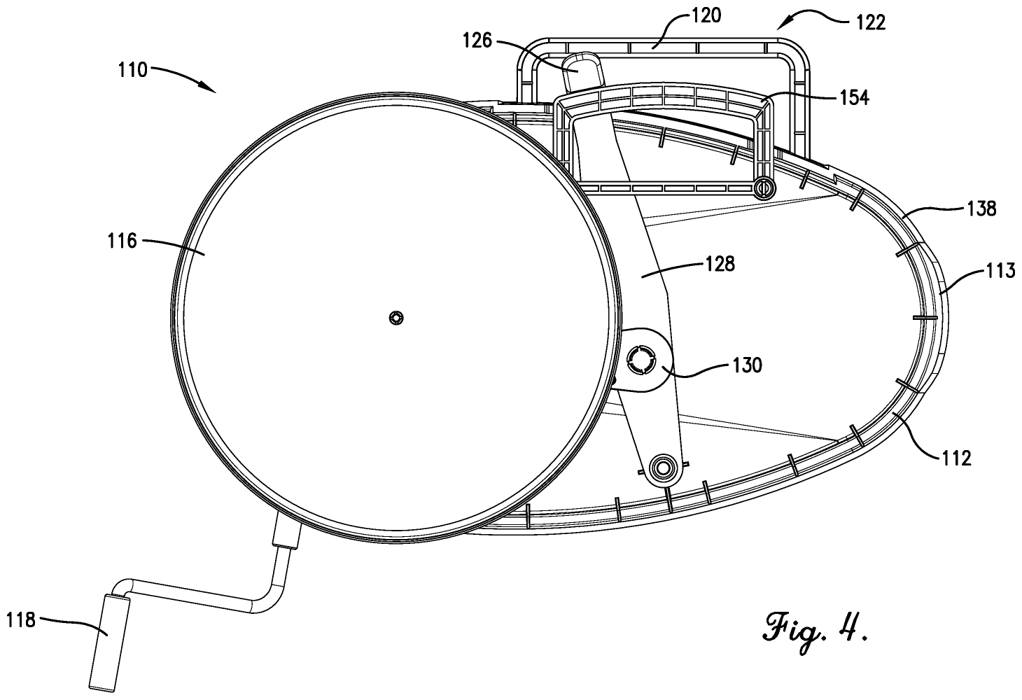

These and other features will become more apparent with reference to the figures. First, FIGS. 1-6 show a first embodiment of a bag spreader 110 according to aspects of the invention. The bag spreader 110 may be used to distribute grass seed about a surface, but can also be used to distribute other granules or particulate material such as, without limitation, fertilizer, other grass treatments, salt, sand, ice melt, and others on a variety of surfaces. For ease of discussion, the operation of each of the bag spreaders 110, 210 discussed herein will be described in connection with grass seed, but the spreaders 110, 210 are not limited to dispersing grass seed and it should be appreciated that other particulate material (e.g. fertilizer, other grass treatments, salt, sand, ice melt, etc.) could be spread in a substantially similar manner without departing from the scope of the invention.

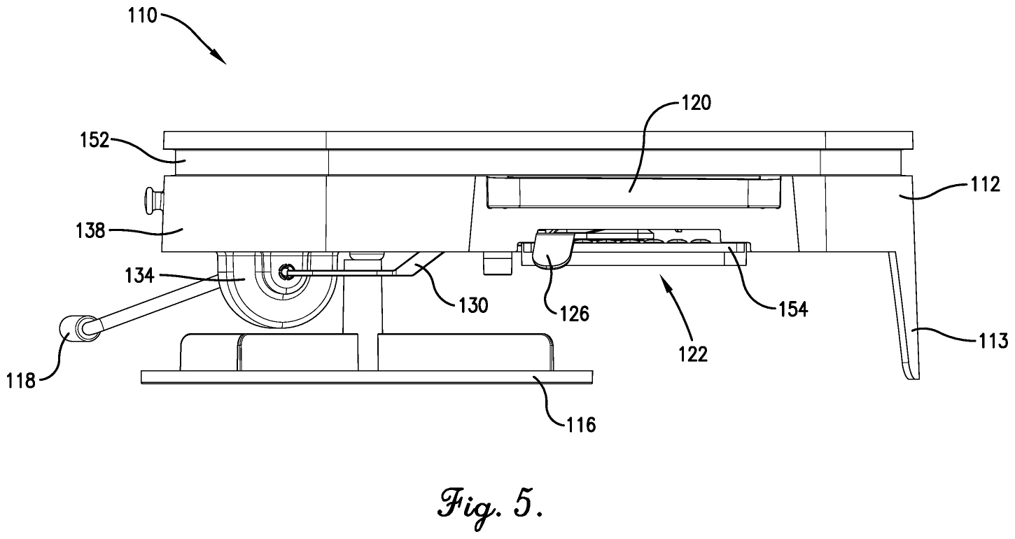

The bag spreader 110 generally includes a base 112, a bag 114 provided above the base 112 and configured to hold grass seed to be spread about a surface, and a rotatable impeller 116 disposed below the base 112 and configured to fling and thus spread the seed about the surface. The base 112 may include one or more extensions such as, in the depicted embodiment, stand 113. The stand 113 serves at least two purposes. First, because the stand 113 is provided at an end of the base 112 that abuts a user's torso during use, the stand 113 provides an area of increased surface area that rests against the user and thus supports and steadies the spreader 110 during use. Second, the stand 113 supports the bag spreader 110 when the spreader 110 is resting on a surface. More particularly, the stand 113 extends downward to an imaginary plane that includes the planar lower surface of the impeller 116 such that when the bag spreader 110 is placed on a surface for storage or for filling the bag 114 with seed, the spreader 110 is generally supported by the planar lower surface of the impeller 116 and the stand 113, as best seen in FIG. 5.

The impeller 116 is disposed below an exit opening 132 provided in the base 112. The impeller 116 receives grass seed falling through the exit opening 132 and flings or otherwise distributes the seed about a surface being treated. The spreader 110 further includes a hand crank 118 operatively connected to the impeller 116 via a rotatable impeller shaft 136 and a gearbox 134 to spin the impeller 116 as the user turns the hand crank 118. The spreader 110 may include a handle 120 used to support and steady the spreader 110 during use and/or a shoulder strap 124 configured to be worn about a user's shoulder and thus further support the bag spreader 110 during use.

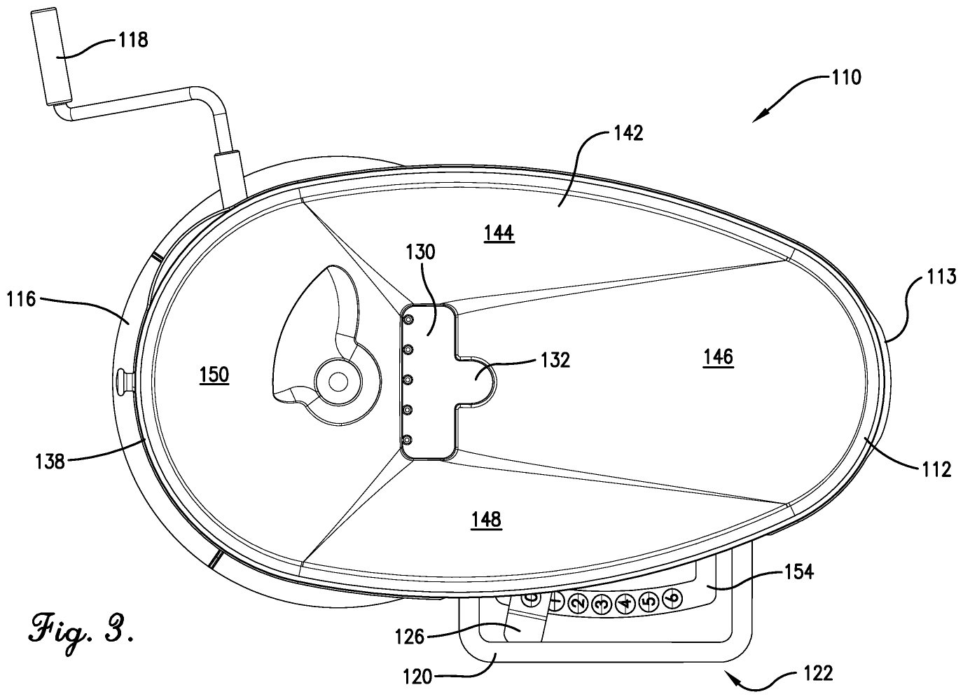

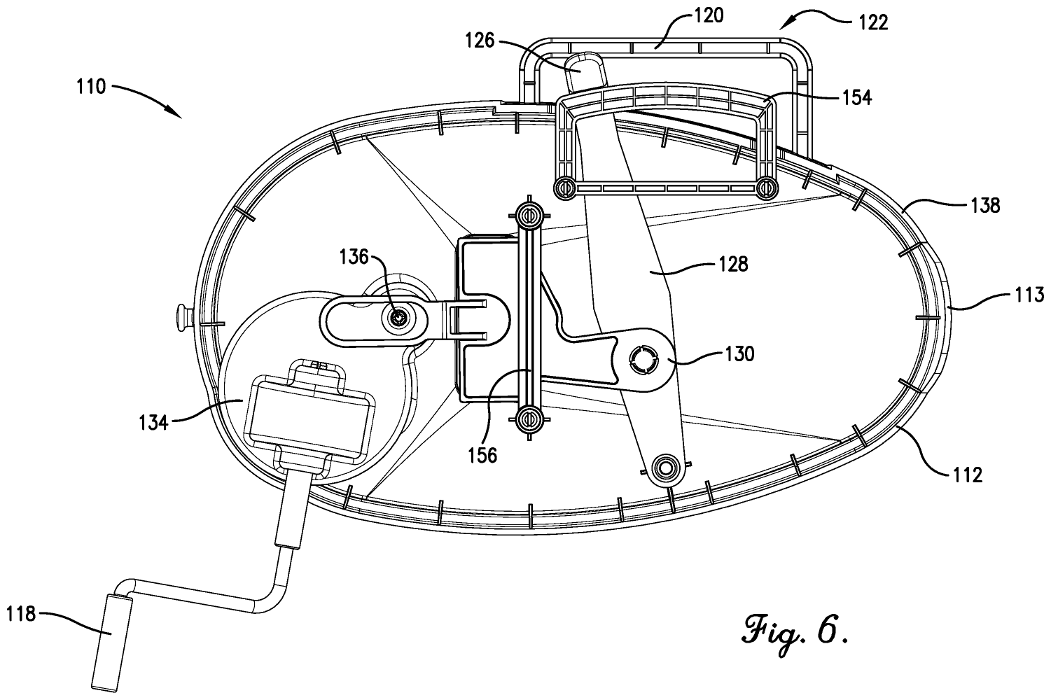

The spreader 110 may also include a rate control 122 used to selectively control an amount of grass seed that passes through the exit opening 132 during use. As best seen in FIG. 3, the rate control 122 generally includes a selector 126 proximate and slidable with respect to a shutoff indicator 154. In some embodiments, the shutoff indicator 154 may include a plurality of numerical settings. During use, a user slides the selector 126 back and forth with respect to the shutoff indicator 154, selecting a setting corresponding to a desired flowrate of the seed being distributed. As best seen in FIG. 6, the selector 125 may be operatively coupled to a pivoting shutoff arm 128, which in turn is pivotably coupled to a sliding shutoff gate 130 abutting and thus covering the exit opening 132 in the floor 142 of the base 112.

The user can thus cause the shutoff gate 130 to selectively open and close the exit opening 132 thereby increasing or decreasing, respectively, grass seed flow from the spreader 110. For example, by sliding the selector 126 to a location corresponding to a higher number on the shutoff indicator 154, the shutoff gate 130 (via the shutoff arm 128) more fully opens the exit opening 132, thereby providing a greater flowrate of grass seed that falls through the opening and onto the impeller 116. The impeller 116 is spun by turning the hand crank 118 (which is operatively connected to the impeller 116 via the gearbox 134), thereby flinging the grass seed about a field or other surface. Conversely, by sliding the selector 126 to a location corresponding to a lower number on the shutoff indicator 154, the shutoff gate 130 (again via the shutoff arm 128) closes the exit opening 132, thereby providing a reduced flowrate of grass seed falling onto the impeller 116 and ultimately distributed about the surface. In some embodiments the rate control 122 may also include a shutoff gate retainer 156 that generally surrounds the shutoff gate 130, keeping the shutoff gate 130 abutting the exit opening 132 as is slides back and forth. The spreader 140 may also include an agitator (not shown) provided on an interior of the base 112—that is, a side of the base facing the interior of the bag 114—which agitates the grass seed and thus assists with moving the grass seed through the exit opening 132.

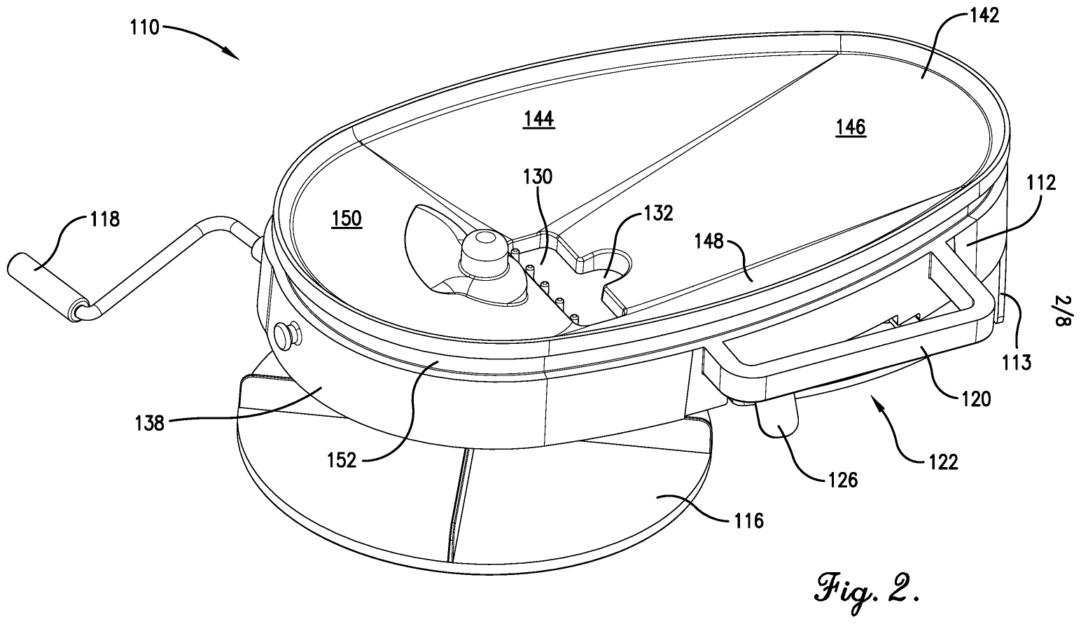

As best seen in FIGS. 2-6, the base 112 of the bag spreader 110 includes a rounded outer circumference. As used herein, “rounded” means a circumference that includes only convexly rounded segments and, optionally, straight segments (i.e., segments with no radius of curvature) connecting convexly rounded segments. Notably, a rounded circumference excludes a circumference having any concave rounded segments (such as a concave indentation configured to abut a user's torso found in known bag spreaders), and also excludes a circumference having to two adjoining straight segments with no rounded segment in between (such as a rectangular circumference).

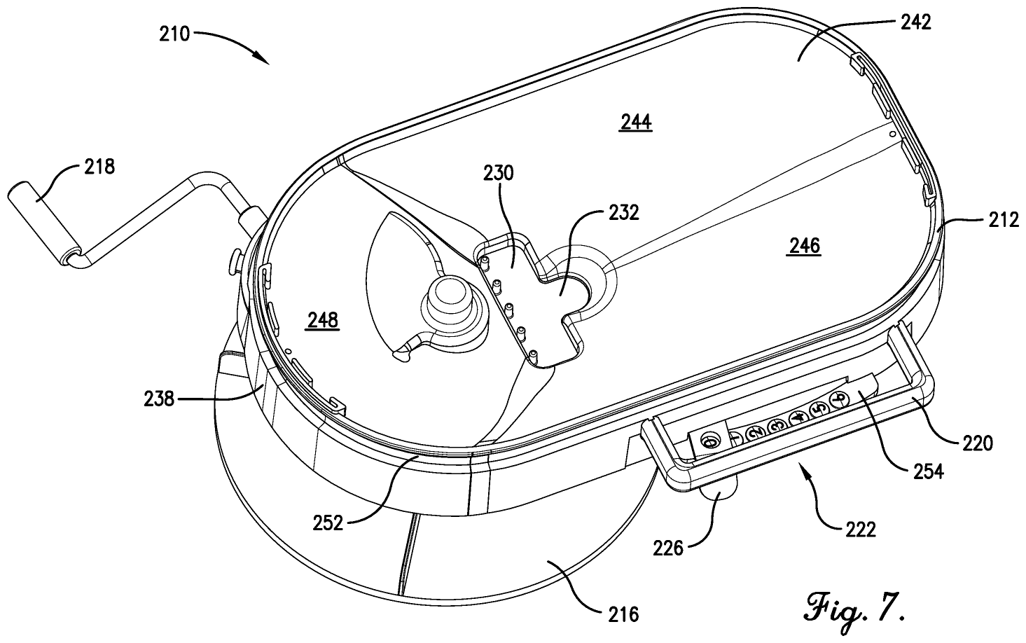

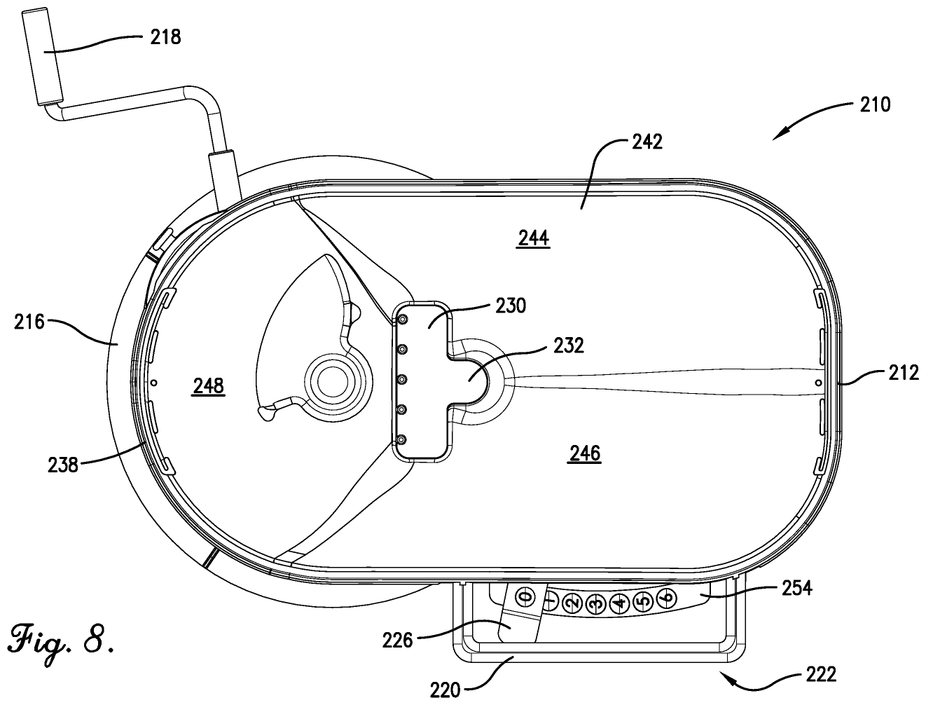

In the embodiment shown in FIGS. 1-6, the rounded base 112 is egg-shaped and includes only convex outer segments. More particularly, the base 112 includes a rounded, egg-shaped circumferentially extending wall 138. In other embodiments the circumferentially extending wall 138 may have other rounded configurations such as, without limitation, an oval shape, a circular shape, a stadium shape, and others, which will become more apparent in connection with the discussion of the embodiment shown in FIGS. 7-8. Unlike the prior-art spreaders that include a “kidney-shaped” outer circumference with a concave indentation that abuts a user's torso, or ones that include a substantially rectangular shaped outer circumference, the rounded circumferentially extending wall 138 eliminates concave indentations and sharp corners, which in turn eliminates areas of the base 112 in which grass seed can become lodged and stuck during use.

Moreover, the rounded outer contour of the base 112 provides for convenient attachment of the bag 114 to the base 112, allowing the bag 114 to be easily removed and replaced as necessary. More particularly, as best seen in FIGS. 2 and 5, the circumferentially extending wall 138 includes a channel 152 therein. The channel 152 circumscribes the base 112 and receives a fastener 158 securing the bag 114 to the base 112. Because of the irregular or boxy outer contours of the bases of prior-art spreaders, the bags thereof must be tucked into the interior of the base and stapled or glued into place so that the open lower end thereof conforms to the irregular circumferentially extending wall. Thus, if a user needs to replace the bag of the prior-art spreaders, they must remove the staples, glue, or other fasteners, then place a replacement bag in its place and staple or glue it to the base, making replacement of the bag tedious. Conversely, in this embodiment the bag 114 is secured by simply sliding the open lower end of the bag 114 around the base 112—and, more particularly, around the circumferentially extending wall 138 of the base 112—and then placing the fastener 158 around the bag 114 in the channel 152 and tightening the fastener 158 to sandwich the bag 114 between the fastener 158 and the channel 152. Because the entirety of the outer circumference of the base 112 includes only segments having a convex radius of curvature, the fastener 158 can be snugly tightened about the base 112—and more particularly about the channel 152—thus firmly holding the bag 114 against the base 112.

The fastener 158 may be any suitable fastener that allows a secure attachment of the bag 114 to the base 112. In one non-limiting example, the fastener 158 is a cable tie (also known as a zip tie). As should be appreciated, a cable tie is an elongated fastener made of a semi-rigid but resilient elastomeric material, most commonly plastic. In one embodiment, the cable tie includes a plurality of teeth proximate a first end and extending along substantially the entire length of the cable tie, while the opposing end includes a head with integral locking mechanism or pawl for receiving and engaging the teeth. To fasten, the first end is thread through the head and pulled tight, engaging each successive tooth with the locking mechanism. As should be appreciated, each tooth is configured to pass through the locking mechanism in only one direction, such that the cable tie can tighten but not loosen. Thus, when fastened about the bag 114 and channel 152, the cable tie 158 is pulled tight to secure the bag 114 in place and will stay fastened until mechanically removed (e.g., cut or the like) from the base 112. Other suitable cable or zip ties could be used to secure the bag including reusable cable ties that do not require a user to destroy (e.g., cut) the tie in order to remove it from the base 112. And in still other embodiments, other types of fasteners could be implemented without departing from the scope of the invention such as a nylon strap with a buckle or similar fastener.

In any event, the rounded outer contour of the base 112 and fastener 158 in combination allow the bag 114 to be quickly fastened to, and later removed from, the base 112. That is, the entire unit need not be replaced if the bag 114 becomes damaged, nor do numerous staples or other semi-permanent fasteners need to be removed to replace a bag 114. Instead, to replace the bag 114 of the spreader 110, a user simply cuts or otherwise removes the fastener 158, slides the replacement bag 114 about the base 112, and fastens a replacement cable tie or other fastener 158 within the channel 152 thus sandwiching the bag 114 between the fastener 158 and the base 112.

The base 112 may also include a sloped floor 142 which enables more efficient filling and emptying of the bag 114. For example, as best seen in FIG. 2 the bag spreader 110 generally includes four sloped floor portions 144, 146, 148, and 150. Although four sloped floor portions 144, 146, 148, and 150 are shown for purposes of discussion, more or less floor portions could be implemented without departing from the scope of the invention, as will become more apparent with discussion of the embodiment shown in FIGS. 7-8. Moreover, it should be appreciated that although, for illustration purposes, four different floor portions 144, 146, 148, and 150 are shown and discussed, the portions of floor 142 are not discretely formed portions but instead are areas of the integrally formed and seamless sloped, funnel-shaped floor 142.

Because in this embodiment the bag 114 is attached to the outside of the base 112 via the fastener 158, no internal lip or the like is needed for receiving the bag and staples. Thus, the outermost portions of the floor 142 can be effectively raised to a location proximate the upper rim of the circumferentially extending wall 138. The floor 142 in turn is generally inclined downward and away from the rim of the circumferentially extending wall 138, extending from the upper rim of the circumferentially extending wall 138 to the exit opening 132. In that regard, the exit opening 132 is provided in a trough at the base of the four sloped floor portions 144, 146, 148, and 150. Accordingly, the sloped floor 142 funnels the grass seed towards the exit opening 132 during use. Unlike the generally planar and horizontal floor of known bag spreaders—which is necessary in order to provide for a sufficient interior lip to receive staples for fastening the bag to the base—on which grass seed can become trapped during use, the sloped floor 142 of the bag spreader 110 thus beneficially provides for fully emptying the bag 114 by channeling the seed to the exit opening 132.

Moreover, when filling the bag spreader 110 with grass seed or other particulate material, the sloped floor 142 lowers and centralizes the center of gravity of the spreader 110 and seed therein, providing enhanced stability as compared to known bag spreaders. More particularly, as a user fills the bag 114 with seed via a reclosable (e.g. zippered) upper opening, the sloped floor 142 channels the seed downward and inward toward the exit opening 132, which is provided near a center of the base 112. During filling, the shutoff gate 130 will fully cover the exit opening 132, and thus the seed will collect first on the shutoff gate 130 at the exit opening 132 and then build up around the exit opening 132 on the surrounding sloped floor 142 before eventually filling the bag 114. The sloped floor 142 thus first concentrates the seed near a center of the base 112 and at the lowermost portion thereof, providing enhanced stability and making it difficult for the spreader to topple during filling.

Aspects of the invention are not limited to the egg-shaped base 112 shown in FIGS. 1-6 but instead are more generally directed to a rounded base (e.g., egg-shaped, oval-shaped, circular, stadium-shaped, etc.) that can beneficially receive a fastener on the exterior thereof to secure the bag to the base and/or that can beneficially employ a sloped floor to lower the spreader's center of gravity during filling and to fully empty the hopper during use. Again, a “rounded” base is one that has a circumference with only convexly rounded segments and, optionally, straight segments (i.e., segments with no radius of curvature) connecting convexly rounded segments, and excludes bases having a circumference comprised of concavely rounded, or indented, segments and/or bases comprised of adjoining straight segments.

For example, FIGS. 7 and 8 show a second embodiment of a bag spreader 210 that includes an alternatively shaped rounded base 212 that provides similar benefits as discussed above with respect to bag spreader 110. The bag spreader 210 generally includes a base 212, bag with shoulder strap (not shown but which are substantially similar to bag 114 and shoulder strap 124 shown in FIG. 1), impeller 216, hand crank 218, handle 220, rate control 222 (including, among other features, a selector 226 and shutoff indication 254), shutoff gate 230, exit opening 232, and a gearbox (not shown). Each of these components is configured to operate in a substantially similar manner as the like-named components discussed in connection with the bag spreader 110, and thus will not be discussed again in detail.

In this embodiment, however, the circumferentially extending wall 238 of the base 212 is not egg-shaped but rather is generally stadium shaped. Nonetheless, because the circumferentially extending wall 238 includes no boxy corners (i.e., portions where two straight segments adjoin) or irregular concave segments (such as concave indentation 40), but instead includes only convexly rounded segments smoothly transitioning to straight side and end segments, the stadium-shaped base 212 is still suitable for receiving a cable tie or similar fastener around an exterior thereof to securely hold the bag in place. That is, the cable tie can still be tightened down around the outer circumference of the base 212 in a similar manner as discussed above. Namely, the circumferentially extending wall 238 includes a recessed channel 252 similar to the channel 152 discussed above to receive a fastener 158 such as a cable tie or similar, and an open lower end of the bag is placed around the base 212 and held in place via the fastener 158 sandwiching the bag between the fastener 158 and the base 212 and more particularly to the channel 252 provided in the circumferentially extending wall 238.

Moreover, the base 212 includes a sloped floor 242 to provide similar benefits as discussed in connection with sloped floor 142. More particularly, the floor 242 in this embodiment generally includes a first floor portion 244, second floor portion 246, and third floor portion 248 that generally extend proximate an upper rim of the circumferentially extending wall 238 to the exit opening 232 provided at a lowermost portion of the floor 242 and near a center of the base 212. Again, the sloped floor 242 funnels grass seed and other particulate material toward the exit opening 232, providing the benefits discussed above.

From the foregoing, it will be seen that this invention is one well adapted to attain all the ends and objects hereinabove set forth together with other advantages which are obvious and which are inherent to the structure. It will be understood that certain features and subcombinations are of utility and may be employed without reference to other features and subcombinations. This is contemplated by and is within the scope of the claims. Since many possible embodiments may be made of the invention without departing from the scope thereof, it is to be understood that all matter herein set forth or shown in the accompanying drawings is to be interpreted as illustrative and not in a limiting sense. Additional objects, advantages, and novel features of the invention will be set forth in part in the description which follows, and in part will become apparent to those skilled in the art upon examination of the following or may be learned by practice of the invention.

What is claimed is:

1. A bag spreader comprising:
a bag configured to hold particulate material to be spread about a surface;
a base removably coupled to the bag and including an exit opening to permit the particulate material to fall therethrough when the particulate material is being spread about the surface;
an impeller below the base and configured to receive the particulate material leaving the exit opening and spread the particulate material about the surface; and
a fastener circumscribing the base and securing the bag to the base.

2. The bag spreader of claim 1, wherein the base includes a circumferentially extending wall, and wherein the fastener circumscribes the circumferentially extending wall.

3. The bag spreader of claim 2, wherein the base further includes a channel within the circumferentially extending wall, and wherein the fastener is at least partly received within the channel.

4. The bag spreader of claim 3, wherein an open lower end of the bag is sandwiched between the fastener and the channel.

5. The bag spreader of claim 4, wherein the fastener is a cable tie.

6. The bag spreader of claim 1, wherein the base includes a circumferentially extending wall including an upper rim, and a sloping floor extending from the upper rim to the exit opening.

7. The bag spreader of claim 6, wherein the base further includes a channel within the circumferentially extending wall, and wherein the channel is disposed proximate the upper rim.

8. The bag spreader of claim 1, wherein an outer circumference of the base includes a convex radius of curvature along the entirety of the outer circumference.

9. The bag spreader of claim 1, wherein an outer circumference of the base includes at least one segment having no radius of curvature and at least one segment having a convex radius of curvature, and wherein no portion of the outer circumference includes a concave radius of curvature.

10. A bag spreader comprising:
a bag configured to hold particulate material to be spread about a surface including an open lower end;
a base including a circumferentially extending wall, a channel within the circumferentially extending wall, and an exit opening to permit the particulate material to fall therethrough when the particulate material is being spread about the surface;
an impeller below the base and configured to receive the particulate material leaving the exit opening and spread the particulate material about the surface; and
a fastener circumscribing the base and the open lower end of the bag, wherein the open lower end of the bag is sandwiched between the fastener and the channel provided in the circumferentially extending wall.

11. The bag spreader of claim 10, wherein the fastener is a cable tie.

12. The bag spreader of claim 10, wherein the circumferentially extending wall includes an upper rim, and wherein the base includes a sloping floor extending from the upper rim to the exit opening.

13. The bag spreader of claim 12, wherein the channel is disposed proximate the upper rim.

14. The bag spreader of claim 10, wherein an outer circumference of the base includes a convex radius of curvature along the entirety of the outer circumference.

15. The bag spreader of claim 10, wherein an outer circumference of the base includes at least one segment having no radius of curvature and at least one segment having a convex radius of curvature, and wherein no portion of the outer circumference includes a concave radius of curvature.

16. A method of operating a bag spreader, the method comprising:
removably securing a bag to a base using a single cable tie;
filling the bag with particulate material; and
turning a hand crank causing an impeller to spin and spread the particulate material passing through an exit opening in the base.

17. The method of claim 16, wherein the bag includes an open lower end, wherein the base includes a circumferentially extending wall and a channel within the circumferentially extending wall, and wherein removably securing the bag to the base includes circumscribing the base and the open lower end of the bag with the cable tie and tightening the cable tie within the channel by feeding a first end of the cable tie through a head provided at a second end of the cable tie and pulling the first end tight.

18. The method of claim 16, wherein the circumferentially extending wall includes an upper rim, and wherein the base includes a sloping floor extending from the upper rim to the exit opening, and wherein during the step of filling the bag with particulate material the sloping floor causes the particulate material to first collect above the exit opening.

19. The method of claim 16 further comprising operating a rate control to selectively open and close the exit opening to permit and restrict, respectively, particulate material passing therethrough.

20. The method of claim 16 further comprising replacing the bag including:
cutting the fastener;
removing the bag from about the base;
placing an open lower end of a replacement bag around the base;
circumscribing the base and the open lower end of the replacement bag with a replacement fastener; and
tightening the replacement fastener within the channel.
